(19) United States
(12) Patent Application Publication
(10) Pub. No.: US 2006/0107232 A1
(43) Pub. Date: May 18, 2006

(54) User interface

(75) Inventors: Bryan David Salt, St. Alband, Hertfordshire (GB); Paul Rowland Beardow, Surrey (GB)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Superscape Group plc, Hook (GB)

(21) Appl. No.: 10/504,037

(22) PCT Filed: Feb. 5, 2003
(86) PCT No.: PCT/GB03/00511

§ 371 Date: Apr. 4, 2005

(30) Foreign Application Priority Data
Feb. 5, 2002 (GB) 0202602.9

(51) Int. Cl. G06F 17/00; G06F 3/00

(52) U.S. Cl. 715/810; 715/864

(57) ABSTRACT

A graphic user interface is provided on a mobile telephone (10) having a screen (12) and control buttons (14) which move and select choices. The screen (12) comprises a viewing area (18), for viewing icons (16), a context area (20) and a selection area (22). A first icon (16), in the viewing area (18), has associated choices (24) displayed. Movement of a choice (24) into the selection area (22) causes the selected item (30) to become the selected second icon (30) in the wiewing area (18), the choices (24B) of the second icon (30) are displayed, and the first icon (16) moves up the context area (20), showing precedence over the second icon (30). Selection (22) of a choice (24B) from the second icon causes a third icon (36) to be in the viewing area (18), the first icon (16) to move further up the context area (20), the second icon (30) to join the first icon (16) in the context area, and further choices (24C) to be displayed for the third icon (36). The sequence of operations continues for further icons. A choice icon can comprise graphic or pictographic images. Movement can be forwards of back, and can include jumping onto an earlier icon in the context area (20).

The present invention relates to user interfaces on electronic equipment. The invention particularly relates to interfaces which permit selection of the function of the equipment. The invention, most particularly, relates to user interfaces for equipment with limited display and control options, such as, but not limited to, cellular telephones and PDA's (Personal Digital Assistants).

User interfaces on constrained devices are often confusing and hard to navigate by users. Display constraints mean that menu options are generally textural rather than graphical, making it hard for the user to retain context, that is, to remember his or her whereabouts in the menu hierarchy. The problem has been most recently manifested with the release of WAP (Wireless Application Protocol) cellular phones which use text to build menu systems and which rapidly become unusable with increasing numbers of services or options from which to select. The present invention seeks to provide a means for user interface which allows the use, at all times, to be aware of his or her position in the menu hierarchy.

Small screen area means that, at any one time, in text based systems, only a small number of menu options can be displayed. One solution to this problem is to allow scrolling up or down. Increased numbers of options can render the confusion and unawareness of position in the menu even worse. The present invention seeks to provide a menu solution where all options accessibly visible on one screen, without loss of user orientation, without loss of simplicity of access, and without loss of user orientation.

Even Graphic User Interfaces (GUI's) are predominantly textural. One has only to examine Microsoft™ Windows™ to find that drop down menus are generally textual. Textual menus shut out individuals that either cannot read, cannot see clearly, or simply do not know the language in which the textual menu is written. The present invention seeks to provide a menu solution which is capable of interpretation by all, without need for a written language.

According to a first aspect, the present invention consists in an interface for electronic equipment including a screen, said interface comprising: a viewing area on said screen for display of the range of choices offered by a current icon: a context area on said screen for display of past icons wherefrom the current icon is derived; and a selection area for selection of a choice from said current icon; where the current icon is moveable into said context area upon selection of a choice therefrom; where past icons are moveable within said context area, upon selection of a choice from said current icon to preserve the order thereof and to introduce said current icon as the most recent past icon; and where the selected choice from said current icon is viewable as a new current icon.

The invention further provides that the viewing area is representable as a three dimensional field.

The invention further provides that the context area is representable as a three dimensional field.

The invention further provides that each icon can include a graphic indicative of its nature.

The invention further provides that the graphic can be ideographic.

The invention further provides that the graphic can be pictographic.

The invention further provides that the interface can operate on a tree structure.

The invention further provides that a new application can be introduced at any stage of selection.

The invention further provides that an application can be removed from any stage of selection whereat it has been installed.

The invention further provides that movement within the interface need not be tree-like.

According to a second aspect, the present invention consists in a method, consistent with the interface above described.

The invention is further explained, by way of an example, by the following description, taken in conjunction with the appended drawings, in which:

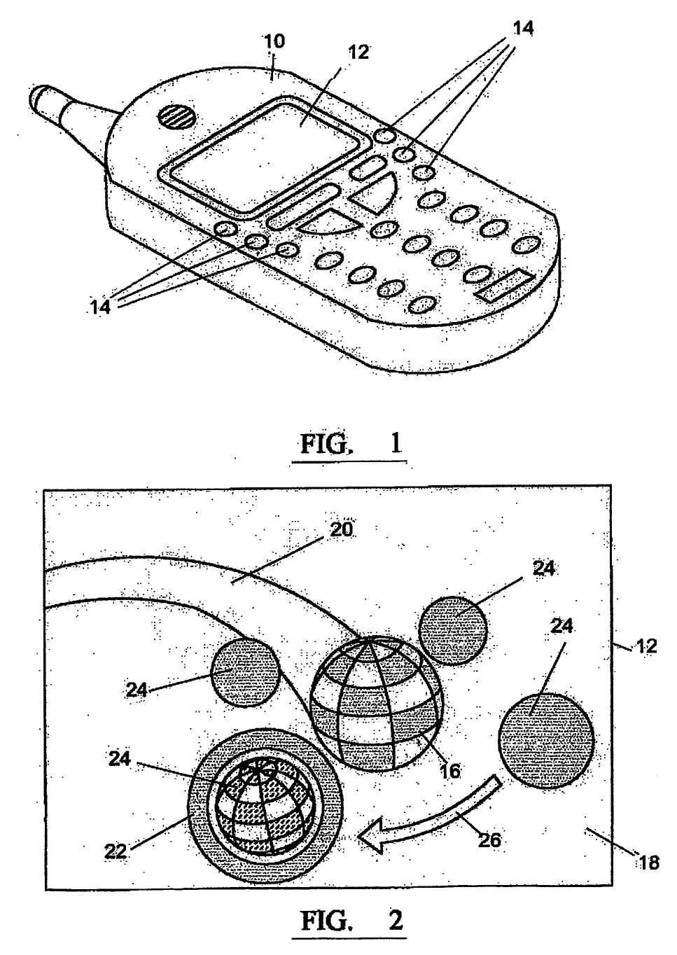

FIG. 1 is an isometric view of an exemplary cellular telephone within which the preferred embodiment of the present invention can be practised.

FIG. 2 is a view of the screen of FIG. 1 at the head or start of a menu selection process.

FIG. 3 shows a second stage in the menu selection process.

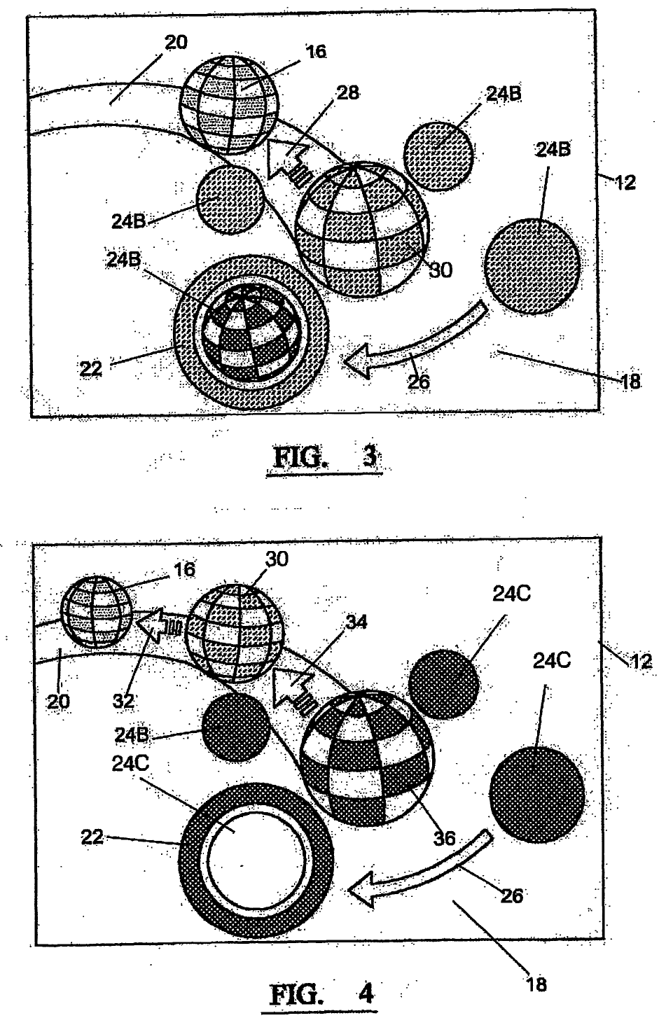

FIG. 4 shows a third stage in the menu selection process.

FIG. 5 is a particular example of an application conducted according to the present invention. And

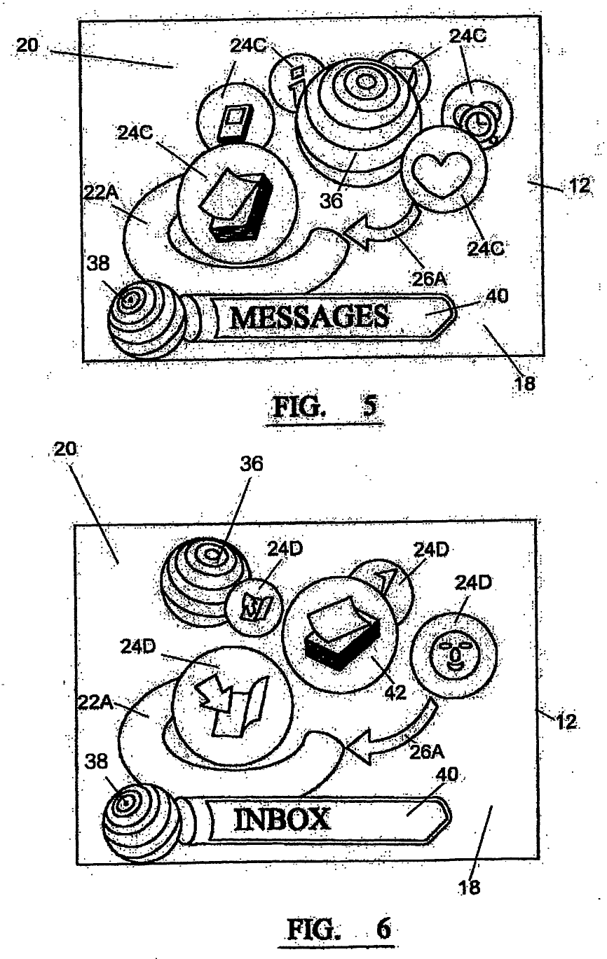

FIG. 6 illustrates how different layers of the application of FIG. 5 can be accessed.

Attention is drawn to FIG. 1 showing an exemplary mobile cellular telephone 10 such as can be used in the preferred embodiment of the present invention. The mobile telephone 10 comprises a screen 12 whereon images can be displayed. Control buttons 14 permit image manipulation on the screen 12.

Attention is next drawn to FIG. 2 showing a first stage of interface operation. The first icon 16 is seen in a viewing area 18 on the screen 12. Since the first icon 16 has no other icon in precedence to it, a context area 20 on the screen 12 is empty. A selection area 22 allows sequential movement of a number of choices 24 into the selection area 22. Movement of the choices 24 is achieved using the control buttons 14. When the desired choice has been placed in the selection area 22, as indicated by arrow 26, further manipulation of the control buttons 14 causes a change to the situation shown in FIG. 3.

FIG. 3 shows a second stage in the manipulation of an interface according to the present invention. The first icon 16 has now moved into the context area 20 as indicated by arrow 28. The choices 24 of the first icon 16 have disappeared. The choice 24 selected in FIG. 2 has now appeared as a second icon 30 in the viewing area 18 of the screen 12. Choices 24A, each associated with the second icon 30, can be moved using the control button 14, as indicated by arrow 26, into the selection area 22. When the desired choice 24A has been entered into the selection area 22, further manipulation of the control buttons 14 causes a change to the situation shown in FIG. 4.

FIG. 4 shows a further stage in the manipulation of the interface. The first icon has been shrunk and moved further into the context area 20, as indicated by arrow 32. The second icon 30 has been moved into the context area 20, as indicated by arrow 34, and its choices 24A are no longer visible. Meanwhile, the choice 24A from the second icon 30 which was in the selection area 22 when the control buttons 14 were employed to cause the change, has become a third icon 36 around which other choices 24C are arrayed in the viewing area 18 of the screen 12. The choices 24C are sequentially positionable, as indicated by arrow 26, in the selection area 22.

As the interface levels are descended, so more icons 16, 30 appear in the context area 20. The context area 20 is organised such that all icons 16, 30, 36 remain visible. This is achieved, in this example, by making the context area 20 a representation of a three-dimensional trail. As an icon 16, 30, 36 progresses up the trail, it becomes smaller. The current icon in the viewing area 18 has its choices 24, 24A, 24B visible. Once an icon 16, 30, 36 moves into the context area 20, its choices are no longer displayed. While, in the examples shown, the number of choices for each icon 16, 30, 36 happens to have numbered four, there is no reason why any such limit should exist. The number of choices can differ between levels of the interface. In particular, when a final choice is made, the number of available choices reduce to just one. Depending upon the history of the mobile telephone 10, the choices can be as low as one (a final solution) or as high as can be. In the event of the number of choices 24, 24A, 24B becoming high, the displayed size of the choices 24, 24A, 24B in the viewing area 18 can be reduced and their packing density increased to permit their viewing. In particular, the size of a choice 24, 24A, 24B is magnified in the selection area 22. While it is desired that a choice 24, 24A, 24B should be identifiable when outside of the selection area 22, it is by no means necessary.

Attention is drawn to FIG. 5, showing an example of an end application such as might be summoned using the interface of the present invention.

The particular example chosen is an e-mail application, similar to Outlook Express™ or Netscape™. The final icon 36 is surrounded by a number of choices 24C. These choices 24C can be moved, as indicated by arrow 26A into a selection area 22A. The choices 24C have images thereon which are pictographic or ideographic to convey to the user of the interface what might be contained therein. A representation 38 of the final icon 36 can be provided next to a message box 40 which indicates, textually, the nature of the choice 24C in the selection box 22A. When the control buttons 14 are used to select the particular choice 24C in the selection area 22A, the situation changes to that shown in FIG. 6.

It is to be appreciated that the form and shape of the context area 20, the selection area-22 and the viewing area 18 can vary between levels.

FIG. 6 has the final icon 36 moving into the context area 20. The choice 24C chosen in the last action becomes the selected icon 42. Choices 24D are sequentially and individually insertable into the selection area 22A, as indicated by arrow 26B. The message box 40 can be used to indicate, textually, what is the nature of the choice 24D in the selection area 22A. On the next move, the messages, available on the “in box” function, will be displayed.

While the present invention has been described with reference to its application to the control of a mobile telephone such as a WAP phone or to a PDA, it is to be appreciated that it can apply to any device which can move through a tree structure state sequence. Non-exclusive examples of such devices include remote controls for television and hi-fi equipment, the television or hi-fi equipment itself, controllers for industrial and medical equipment, and, indeed, any device where a number of choices are offered to be used or to be adjusted by the user.

While the described example shows only movement in the interface towards a final application at a branch end of a tree structure, it is to be appreciated that the control buttons 14 can equally be used to move backwards toward the tree root, to select other choices of branch, and even to jump from any one icon to any other icon in the context area to effect change.

1-20. (canceled)

21. An interface for electronic equipment including a screen, said interface comprising:
a viewing area on said screen for display of the range of choices offered by a current icon:
a context area on said screen for display of past icons wherefrom the current icon is derived; and
a selection area for selection of a choice from said current icon;
where the current icon is moveable into said context area upon selection of a choice therefrom; where past icons are moveable within said context area, upon selection of a choice from said current icon to preserve the order thereof and to introduce said current icon as the most recent past icon; and where the selected choice from said current icon is viewable as a new current icon.

22. An interface according to claim 21, wherein said viewing area is represented as a three-dimensional field.

23. An interface according to claim 21, wherein said context area is represented as a three-dimensional field.

24. An interface according to claim 21, wherein each icon can include a graphic indicative of its nature.

25. An interface according to claim 24, wherein said graphic is ideographic.

26. An interface according to claim 24, wherein said graphic is pictographic.

27. An interface according claim 21, wherein the interface is arranged to be operative to support and use a tree structure.

28. An interface according to claim 21, wherein the interface is arranged to be operative to allow a new application to be introduced at any stage of selection.

29. An interface according to claim 21, wherein the interface is arranged to be operative to allow an application can be removed from any stage of selection whereat it has been installed.

30. An interface according to claim 21, wherein the interface is arranged to be operative to support movement within said interface which is not tree-like.

31. A method for operating an interface for electronic equipment including a screen, said method including the steps of:
employing a first portion of said screen as a viewing area for display of the range of choices offered by a current icon:
employing a second portion of said screen as a context area for display of past icons wherefrom the current icon is derived; and
employing a third portion of said screen as a selection area for selection of a choice from said current icon;
moving the current icon into said context area upon selection of a choice therefrom;
moving past icons within said context area, upon selection of a choice from said current icon to preserve the order thereof and to introduce said current icon as the most recent past icon; and
viewing the selected choice as a new current icon.

32. A method according to claim 31, further comprising the step of representing said viewing area as a three-dimensional field.

33. A method according to claim 31, further comprising the step of representing said context area as a three-dimensional field.

34. A method according to claim 31, further comprising the step of including, in each icon, a graphic indicative of its nature.

35. A method according to claim 34, wherein said graphic is ideographic.

36. A method according to claim 34, wherein said graphic is pictographic.

37. A method according to claim 31, further comprising the step of permitting operation of the interface based on a tree structure.

38. A method according to claim 31, further comprising the step of permitting a new application to be introduced at any stage of selection.

39. A method according to claims 31, further comprising the step of allowing an application to be removed from any stage of selection whereat it has been installed.

40. A method according to claim 31, further comprising the step of supporting movement within said interface which is not tree-like.

41. An interface for electronic equipment including a screen, said interface comprising:
a viewing area on said screen for display of the range of choices offered by a current icon;
the viewing area being represented as a three-dimensional field;
a context area on said screen for display of past icons wherefrom the current icon is derived, the context area being represented as a three-dimensional field; and
a selection area for selection of a choice from said current icon;
where the current icon is moveable into said context area upon selection of a choice therefrom; where past icons are moveable within said context area, upon selection of a choice from said current icon to preserve the order thereof and to introduce said current icon as the most recent past icon; where the selected choice from said current icon is viewable as a new current icon, and where each icon includes a graphic indicative of its nature.

42. An interface according claim 41, wherein the interface is arranged to be operative to support and use a tree structure.

43. An interface according to claim 41, wherein the interface is arranged to be operative to support movement within said interface which is not tree-like.

44. An interface for electronic equipment including a screen, said interface comprising:
a viewing area on said screen for display of the range of choices offered by a current icon;
the viewing area being represented as a three-dimensional field;
a context area on said screen for display of past icons wherefrom the current icon is derived, the context area being represented as a three-dimensional field; and
a selection area for selection of a choice from said current icon;
where the current icon is moveable into said context area upon selection of a choice therefrom; where past icons are moveable within said context area, upon selection of a choice from said current icon to preserve the order thereof and to introduce said current icon as the most recent past icon; where the selected choice from said current icon is viewable as a new current icon, and where each icon includes a graphic indicative of its nature, the interface being is arranged to be operative to allow a new application to be introduced at any stage of selection and be removed from any stage of selection whereat it has been installed.
